(19) United States
(12) Patent Application Publication
(10) Pub. No.: US 2003/0093513 A1
(43) Pub. Date: May 15, 2003

(54) Methods, systems and computer program products for packetized voice network evaluation

(76) Inventors: Jeffrey Todd Hicks, Cary, NC (US); John Lee Wood, Raleigh, NC (US); Carl Eric Sommer, Raleigh, NC (US); Edward Adams Robie JR., Raleigh, NC (US)

Correspondence Address: MYERS BIGEL SIBLEY & SAJOVEC, PO BOX 37428, RALEIGH, NC, 27627, US

(21) Appl. No.: 09/951,050

(22) Filed: Sep. 11, 2001

(51) Int. Cl. G06F 15/173

(52) U.S. Cl. 709/224

(57) ABSTRACT

Methods, systems and computer program products are provided for testing a network that supports packetized voice communications. Execution of a network test protocol associated with the packetized voice communications is initiated and obtained performance data for the network based on the initiated network test protocol is automatically received. The obtained performance data is mapped to terms of an overall transmission quality rating. The overall transmission quality rating is generated based on the mapped obtained performance data.

### FIELD OF THE INVENTION

The present invention, generally, relates to network communication methods, systems and computer program products and, more particularly, to methods, systems and computer program products for performance testing of computer networks.

### BACKGROUND OF THE INVENTION

Companies are often dependent on mission-critical network applications to stay productive and competitive. To achieve this, information technology (IT) organizations preferably provide reliable application performance on a 24-hour, 7-day-a-week basis. One known approach to network performance testing to aid in this task is described in U.S. Pat. No. 5,881,237 entitled “Methods, Systems and Computer Program Products for Test Scenario Based Communications Network Performance Testing,” which is incorporated herein by reference as if set forth in its entirety. As described in the '237 patent, a test scenario simulating actual applications communication traffic on the network is defined. The test scenario may specify a plurality of endpoint node pairs on the network that are to execute respective test scripts to generate active traffic on the network while measuring various performance characteristics while the test is executing. The resultant data may be provided to a console node, coupled to the network, which initiates execution of the test scenario by the various endpoint nodes. The endpoint nodes may execute the tests as application level programs on existing endpoint nodes of a network to be tested, thereby using the actual protocol stacks of such devices without reliance on the application programs available on these endpoints.

One application area of particular interest currently is in the use of a computer network to support voice communications. More particularly, packetized voice communications are now available using data communication networks, such as the Internet and intranets, to support voice communications typically handled in the past over the conventional telephone switched telecommunications network (such as the public switched telephone network (PSTN)). Calls over a data network typically rely on codec hardware and/or software for voice digitization so as to provide the packetized voice communications. However, unlike conventional data communications, user perception of call quality for voice communications is typically based on their experience with the PSTN, not with their previous computer type application experiences. As a result, the types of network evaluation supported by the various approaches to network testing described above are limited in their ability to model user satisfaction for this unique application.

A variety of different approaches have been used in the past to provide a voice quality score for voice communications. The conventional measure from the analog telephone experience is the Mean Opinion Score (MOS) described in ITU-T recommendation P.800 available from the International Telecommunications Union. In general, the MOS score is derived from the results of humans listening and grading what they hear from the perspective of listening quality and listening effort. A Mean Opinion Score ranges from a low of 1.0 to a high of 5.0.

The MOS approach is beneficial in that it characterizes what humans think at a given time based on a received voice signal. However, human MOS data may be expensive and time consuming to gather and, given its subjective nature, may not be easily repeatable. The need for humans to participate as evaluators in a test every time updated information is desired along with the need for a VoIP equipment setup for each such test contribute to these limitations of the conventional human MOS approach. Such advance arrangements for measurements may limit when and where the measurements can be obtained. Human MOS is also generally not well suited to tuning type operations that may benefit from simple, frequent measurements. Human MOS may also be insensitive to small changes in performance such as those used for tuning network performance by determining whether an incremental performance change following a network change was an improvement or not.

Objective approaches include the perceptual speech quality measure (PSQM) described in ITU-T recommendation P.861, the perceptual analysis measurement system (PAMS) described by British Telecom, the measuring normalized blocks (MNB) measure described in ITU-T P.861 and the perceptual evaluation of speech quality (PESQ) described in ITU-T recommendation P.862. Finally, the E-model, which describes an “R-value” measure, is described in ITU-T recommendation G.107. The PSQM, PAMS and PESQ approaches typically compare analog input signals to output signals that may require specialized hardware and real analog signal measurements.

From a network perspective, evaluation for voice communications may differ from conventional data standards, particularly as throughput and/or response time may not be the critical measures. A VoIP phone call generally consists of two flows, one in each direction. Such a call typically does not need much bandwidth. However, the quality of a call, how it sounds, generally depends on three things: the one-way delay from end to end, how many packets are lost and whether that loss is in bursts, and the variation in arrival times, herein referred to as jitter.

In light of these differences, it may be desirable to determine if a network is even capable of supporting VoIP before deployment of such a capability. If the initial evaluation indicates that performance will be unsatisfactory or that existing traffic will be disrupted, it would be helpful to determine what to change in the network architecture to provide an improvement in performance for both VoIP and the existing communications traffic. As the impact of changes to various network components may not be predictable, thus requiring empirical test results, it would also be desirable to provide a repeatable means for iteratively testing a network to isolate the impact of individual changes to the network configuration.

However, the various voice evaluation approaches discussed above do not generally factor in human perception, acoustics or the environment effectively in a manner corresponding to human perception of voice quality. Such approaches also typically do not measure in two directions at the same time, thus, they may not properly characterize the two RTP flows of a VoIP call, one in each direction. These approaches also do not typically scale to multiple simultaneous calls or evaluate changes during a call, as compared with a single result characterizing the entire call. Of these models, only the E-model is generally network based in that it may take into account network attributes, such as codec, jitter buffer, delay and packet loss and model how these affect call quality scores. Therefore, improved approaches to testing of networks for VoIP traffic would be beneficial.

### SUMMARY OF THE INVENTION

Embodiments of the present invention provide methods, systems and computer program products for evaluating a network that supports packetized voice communications. Execution of a network test protocol associated with the packetized voice communications is initiated, and obtained performance data for the network based on the initiated network test protocol is automatically received. The obtained performance data is mapped to terms of an overall transmission quality rating. The overall transmission quality rating is generated based on the mapped obtained performance data.

In further embodiments of the present invention, the generated overall transmission quality rating is stored with an associated time based on when the network test protocol is executed, to provide benchmarking of network performance. In addition, a plurality of non-measured parameter values may be associated with the initiated network test protocol and the overall transmission quality rating may be generated based on the mapped obtained performance data and the associated plurality of non-measured parameter values. The packetized voice communications may be voice over Internet protocol (VoIP) communications and the overall transmission quality rating may be an R-value. The R-value may also be converted to an estimated Mean Opinion Score (MOS).

In other embodiments of the present invention, the obtained performance data is at least one of a one-way network delay, a network packet loss, a jitter buffer packet loss and a network packet burst loss. Note that, as used herein, “network packet burst loss” refers to whether network packet loss during a time interval is characterized as “random” or “bursty.” The network test protocol may specify a communication from a first node on the network to a second node on the network. The one-way network delay performance data may be automatically obtained by synchronizing a clock at the first node and a clock at the second node and determining a transmission latency for the communication of the voice packets from the first node to the second node.

The synchronizing of a clock at the first node and a clock at the second node in various embodiments includes establishing a first software clock at the first node and a second software clock at the second node. Packets are transmitted from the first node to the second node, the packets including a time of transmission record based on the first software clock. A synchronization record is generated at the second node based on the received time of transmission records and the second software clock. Operations may be intermittently repeated to update the synchronization record.

In further embodiments of the present invention, the performance data is automatically obtained based on a executed network test protocol which specifies communication packets from a first node on the network to a second node on the network. Operations related to automatically obtaining the performance data include determining a one-way delay between the first and second node based on the communication packets from the first node to the second node. In addition, a network packet loss is determined based on the communication packets from the first node to the second node. A jitter buffer packet loss may also be determined based on the communication packets from the first node to the second node. The overall transmission quality rating may be an R-value including an equipment impairment (Iₑ) term and a delay impairment (I_{d}) term. The delay impairment (I_{d}) may be determined based on the determined one-way delay. The equipment impairment (Iₑ) may be determined based on the determined network packet loss and may further be based on a jitter buffer packet loss, as well as the “random” or “bursty” nature of the packet loss and may also be based on the codec utilized in the system. The network test protocol may specify communication packets between a plurality of network node pairs, and the one-way delay and network packet loss and packet loss character may be determined based on the communication packets between the plurality of network node pairs.

In other embodiments of the present invention, methods are provided for evaluating a network that supports voice over internet protocol (VOIP) communications. Execution of a network test protocol selected to emulate VoIP communications through communication traffic generated between selected nodes of the network is initiated. Obtained performance data for the network based on the initiated network test protocol is automatically obtained. The obtained performance data provides at least one of one-way delay measurements between ones of the selected nodes and packet loss measurements between ones of the selected nodes. The one-way delay measurements are mapped to a delay impairment (I_{d}) term of an R-value and the packet loss measurements are mapped to an equipment impairment (Iₑ) term of the R-value. The R-value is generated based on the mapped measurements.

In further embodiments of the present invention, systems are provided for evaluating a network that supports packetized voice communications. The systems include a test initiation module that transmits over the network, to nodes coupled to the network, a request to initiate execution of a network test protocol associated with the packetized voice communications. A receiver receives over the network obtained performance data for the network based on the initiated network test protocol. A voice performance characterization module maps the obtained performance data to terms of an overall transmission quality rating and generates the overall transmission quality rating based on the mapped obtained performance data.

While described above primarily with reference to methods, systems and computer program products are also provided.

### BRIEF DESCRIPTION OF THE DRAWINGS

FIG. 1 is a block diagram of a hardware and software environment in which the present invention may operate according to embodiments of the present invention;

FIG. 2 is a block diagram of a data processing system according to embodiments of the present invention;

FIG. 3A is a more detailed block diagram of data processing systems implementing a control node according to embodiments of the present invention;

FIG. 3B is a more detailed block diagram of data processing systems implementing an endpoint node according to embodiments of the present invention;

FIG. 4 is a graphical illustration of a mapping of an R-value to an estimated Mean Opinion Score (MOS) suitable for use with embodiments of the present invention;

FIG. 5 is a flow chart illustrating operations for testing a network that supports packetized voice communications according to embodiments of the present invention from the perspective of a control node;

FIG. 6 is a flow chart illustrating operations for testing a network that supports packetized voice communications according to embodiments of the present invention from the perspective of an endpoint node;

FIG. 7 is a flow chart illustrating operations related to synchronizing clocks at different nodes of a network according to embodiments of the present invention;

FIG. 8 is a flow chart illustrating operations for testing a network that supports packetized voice communications according to embodiments of the present invention from the perspective of a console node;

FIG. 9 is a schematic illustration of an MOS output screen of a graphical user interface according to embodiments of the present invention; and

FIGS. 10A-10D are graphical illustrations of voice performance characteristics for a variety of Codec devices.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code means embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java® or C++. However, the computer program code for carrying out operations of the present invention may also be written in conventional procedural programming languages, such as the “C” programming language or assembly language. The program code may execute entirely on the user's computer, partly on the user's computer, as a stand alone software package, partly on the user's computer and partly on a remote computer, or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

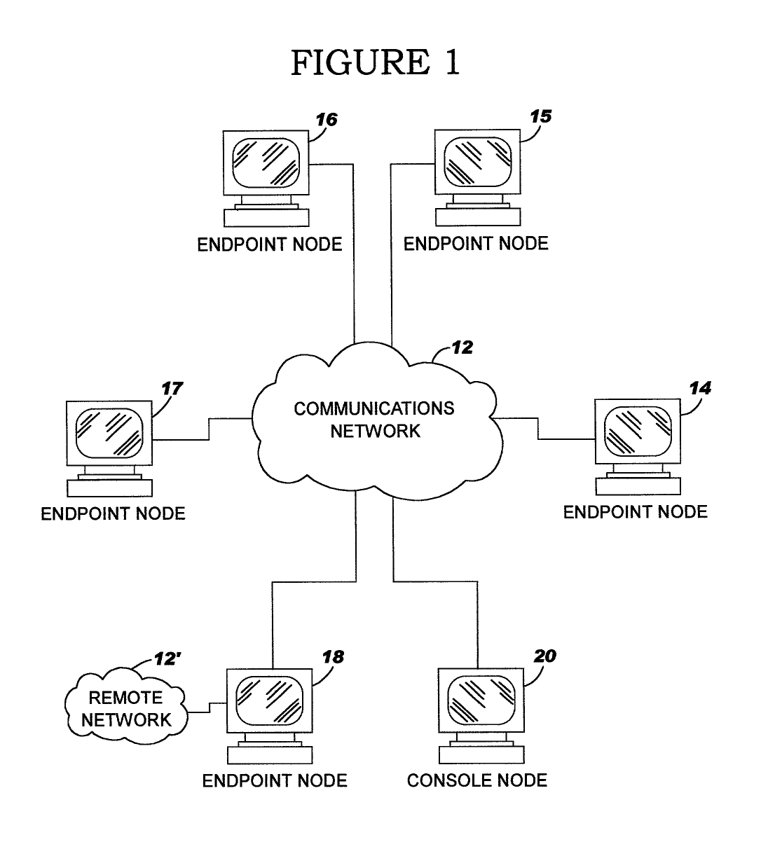

The present invention will now be described with reference to the embodiments illustrated in the figures. Referring first to FIG. 1, embodiments of site based dynamic distribution systems according to the present invention will be further described. A hardware and software environment in which the present invention can operate as shown in FIG. 1 will now be described. As shown in FIG. 1, the present invention includes systems, methods and computer program products for testing the performance of a communications network 12. Communications network 12 provides a communication link between the endpoint nodes 14, 15, 16, 17, 18 supporting packetized voice communications and further provides a communication link between the endpoint nodes 14, 15, 16, 17, 18 and the console node 20.

As will be understood by those having skill in the art, a communications network 12 may be comprised of a plurality of separate linked physical communication networks which, using a protocol such as the Internet protocol, may appear to be a single seamless communications network to user application programs. For example, as illustrated in FIG. 1, remote network 12′ and communications network 12 may both include a communication node at endpoint node 18. Accordingly, additional endpoint nodes (not shown) on remote network 12′ may be made available for communications from endpoint nodes 14, 15, 16, 17. It is further to be understood that, while for illustration purposes in FIG. 1 communications network 12 is shown as a single network, it may be comprised of a plurality of separate interconnected physical networks. As illustrated in FIG. 1, endpoint nodes 14, 15, 16, 17, 18 may reside on a computer. As illustrated by endpoint node 18, a single computer may comprise multiple endpoint nodes. Performance testing of the present invention as illustrated in FIG. 1 further includes a designated console node 20. The present invention tests the performance of communications network 12 by the controlled execution of packetized voice type communication traffic between the various endpoint nodes 14, 15, 16, 17, 18 on communications network 12. While it is preferred that packetized voice communication traffic be simulated by endpoint node pairs, it is to be understood that console node 20 may also perform as an endpoint node for purposes of a performance test. It is also to be understood that any endpoint node may be associated with a plurality of additional endpoint nodes to define a plurality of endpoint node pairs.

Console node 20, or other means for controlling testing of network 12, obtains user input, for example, by keyed input to a computer terminal or through a passive monitor, to determine a desired test. Console node 20, or other control means further defines a test scenario to emulate/simulate packetized voice communications traffic between a plurality of selected endpoint nodes 14, 15, 16, 17, 18. Preferably, the test scenario is an endpoint pair based test scenario. Each endpoint node 14, 15, 16, 17, 18 is provided endpoint node information, including an endpoint node specific network communication test protocol based on the packetized voice communication traffic expected, to provide a test scenario which simulates/emulates the voice communication traffic. Console node 20 may construct the test scenario, including the underlying test protocols, and console node 20, or other initiating means, initiates execution of network test protocols for testing network performance. Test protocols may contain all of the information about a performance test including which endpoint nodes 14, 15, 16, 17, 18 to use and what test protocol and network protocol to use for communications between each pair of the endpoint nodes. The test protocol for a pair of the endpoint nodes may include a test protocol script. A given test may include network communications test protocols including a plurality of different test protocol scripts. The console node 20 may also generate an overall transmission quality rating for the network 12.

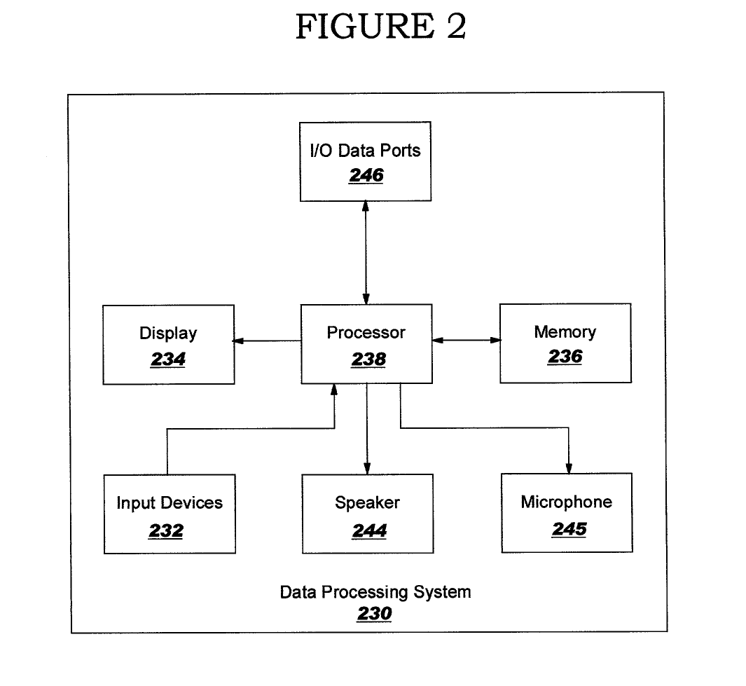

FIG. 2 illustrates an exemplary embodiment of a data processing system 230 in accordance with embodiments of the present invention. The data processing system 230 typically includes input device(s) 232 such as a keyboard or keypad, a display 234, and a memory 236 that communicate with a processor 238. The data processing system 230 may further include a speaker 244, a microphone 245 and an I/O data port(s) 246 that also communicate with the processor 238. The I/O data ports 246 can be used to transfer information between the data processing system 230 and another computer system or a network 12, for example, using an internet protocol (IP) connection. These components may be conventional components such as those used in many conventional data processing systems which may be configured to operate as described herein.

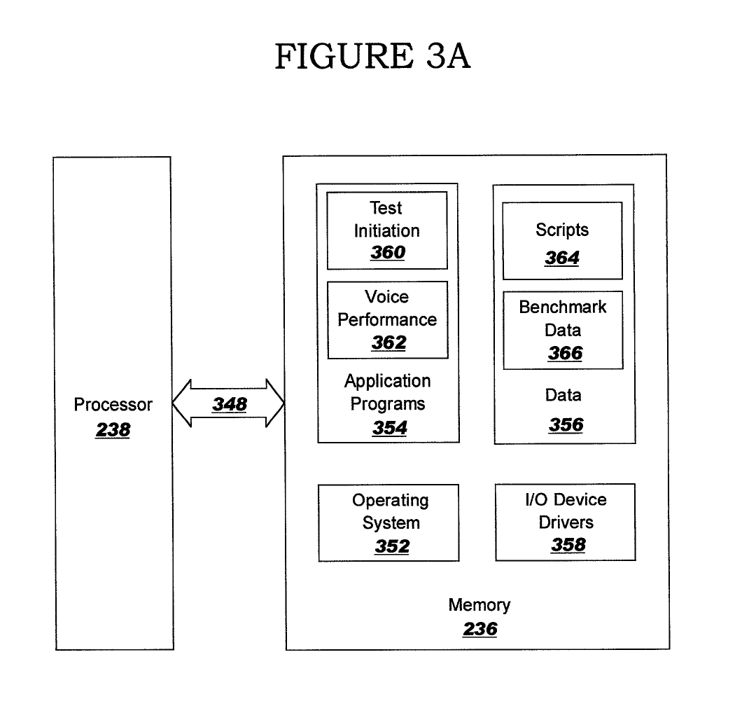

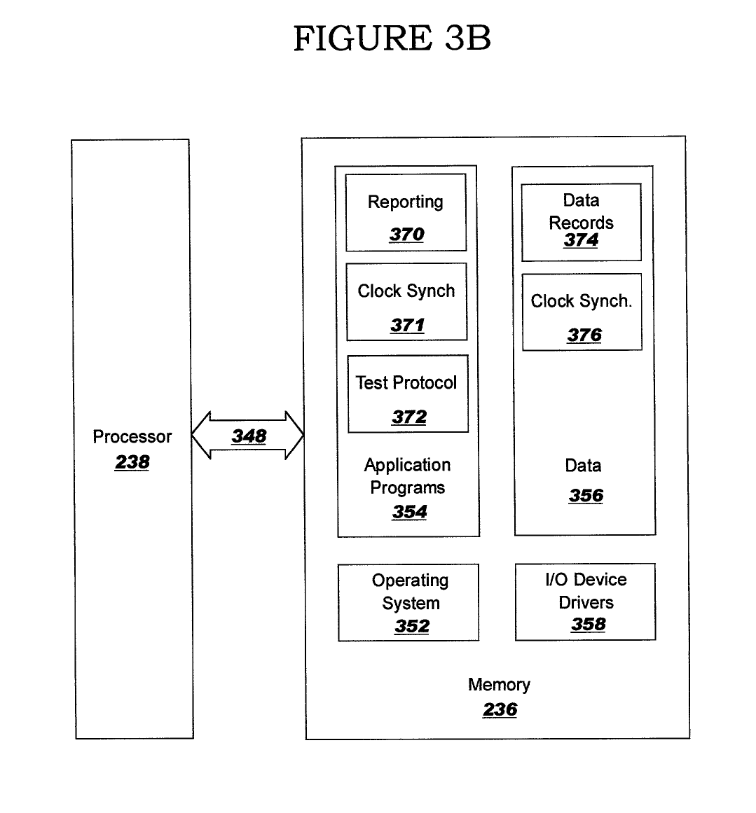

FIGS. 3A and 3B are block diagrams of embodiments of data processing systems that illustrate systems, methods, and computer program products in accordance with embodiments of the present invention. The processor 238 communicates with the memory 236 via an address/data bus 348. The processor 238 can be any commercially available or custom microprocessor. The memory 236 is representative of the overall hierarchy of memory devices containing the software and data used to implement the functionality of the data processing system 230. The memory 236 can include, but is not limited to, the following types of devices: cache, ROM, PROM, EPROM, EEPROM, flash memory, SRAM, and DRAM.

As shown in FIG. 3A, the memory 236 may include several categories of software and data used in the data processing system 230: the operating system 352; the application programs 354; the input/output (I/O) device drivers 358; and the data 356. As will be appreciated by those of skill in the art, the operating system 352 may be any operating system suitable for use with a data processing system, such as Solaris from Sun Microsystems, OS/2, AIX or System390 from International Business Machines Corporation, Armonk, N.Y., Windows95, Windows98, Windows NT, Windows ME or Windows2000 from Microsoft Corporation, Redmond, Wash., Unix or Linux. The I/O device drivers 358 typically include software routines accessed through the operating system 352 by the application programs 354 to communicate with devices such as the input devices 232, the display 234, the speaker 244, the microphone 245, the I/O data port(s) 246, and certain memory 236 components. The application programs 354 are illustrative of the programs that implement the various features of the data processing system 230 and preferably include at least one application which supports operations according to embodiments of the present invention. Finally, the data 356 represents the static and dynamic data used by the application programs 354, the operating system 352, the I/O device drivers 358, and other software programs that may reside in the memory 236.

Note that while the present invention will be described herein generally with reference to voice over IP (VOIP) communications, the present invention is not so limited. Thus, while the present invention is generally described with reference to VoIP herein, it will be understood that the present invention may be utilized to test networks supporting any packetized audio or video protocol.

As is further seen in FIG. 3A, the application programs 354 in a console node device may include a test initiation module 360 that transmits a request to initiate execution of a network test protocol to a plurality of endpoint nodes connected to a network to be tested. The request may be transmitted through the I/O data ports 246 which provide a means for transmitting the request and also provide a receiver that receives, for example, over the network 12 obtained performance data from the endpoint nodes based on the initiated network test protocol. Thus, in various embodiments of the present invention, the request to initiate a test as well as the reported obtained performance data may be communicated between a console node device and endpoint node devices on the network to be tested.

As is further shown in FIG. 3A, the application programs 354 in a console node device 20 may also include a voice performance characterization module 362 that maps the obtained performance data to terms of an overall transmission quality rating. The voice performance characterization module 362 may also generate the overall transmission quality rating based on the mapped obtained performance data.

Additional aspects of the data 356 in accordance with embodiments of the present invention are also illustrated in FIG. 3A. As shown in FIG. 3A, the data 356 includes scripts 364 which may be used in defining a network test protocol for a test of the network. One or more scripts may be provided to emulate packetized voice communications, such as VoIP communications, by generating traffic between selected endpoint nodes 14, 15, 16, 17, 18 of the network as specified by the network test protocol which is initiated at selected intervals by the console node device 20. In addition to supporting snap shot “real” time measurements of network performance for packetized voice communications, benchmark historical data may also be provided for the embodiments illustrated in FIG. 3A as shown by the benchmark data 366. Thus, overall transmission quality ratings for a network being tested may be stored with associated time of measurement information based on when the corresponding network test protocol was executed to build a history of voice communication performance characteristics for the network over a period of time.

Referring now to FIG. 3B, aspects related to a processor 238 configured to operate as an endpoint node 14, 15, 16, 17, 18 according to various embodiments of the present invention will now be further described. Like numbered features shown in FIG. 3B correspond to those in FIG. 3A and will not be further described herein. For an endpoint node device, the I/O data ports 246 may operate to provide a receiver coupled to the network that receives the request to initiate execution of a network test protocol. The application programs 354, as shown in FIG. 3B, include a test protocol module 372 that executes the network test protocol responsive to a received request to initiate execution of the protocol. The test protocol module 372 thus operates to provide the performance data from execution of the network test protocol. It is to be understood that the test protocol may configure a particular application program test protocol module 372 to support one or more connections to one or more associated endpoint nodes by generating network traffic emulating packetized voice communications and making relevant measurements, such as one-way delay and packet loss, for the generated traffic between the endpoint node pairs. The application programs 354 as illustrated in FIG. 3B further include a reporting module 370 that transmits the obtained performance data to a control node 20 over the network 12 and a clock synchronization module 371 that may be used to support the test protocol module 372 in obtaining measurements, such as delay measurements for packets, by synchronizing clocks of nodes of a test pair.

FIG. 3B also illustrates various aspects of the data 356 included in endpoint node devices according to embodiments of the present invention. The data records 374 are the stored measurement values. In various embodiments, the stored measurement values may be stored, for example, as a one-way delay measurement or as individual time of transmission and/or receipt for particular ones of the emulated voice packets transmitted during the tests. The data may also be stored in a more processed form, such as time difference records or averaged or otherwise processed records, for a plurality of transmitted emulation packets and/or between a plurality of different endpoint nodes. Furthermore, the data may be processed further to generate the one-way delay measurements or other measurements which are to be directly mapped into terms of the overall transmission quality rating and then stored in the processed form. Alternatively, the conversion into the obtained performance data format suitable for mapping to terms of the overall transmission quality rating may be performed at the console node 20 based on raw data reported from ones of the endpoint nodes 14, 15, 16, 17, 18 participating in a network test protocol execution event.

Clock synchronization data records 376 are also provided in the data 356 as shown in the embodiments of FIG. 3B. The clock synchronization records 376 may contain clock synchronization information for only a single other endpoint node connected to the network or for a plurality of different endpoint nodes connected to the network, ones of which may be selected for communications by a particular network test protocol at different times which information may be utilized and generated by the clock synchronization module 371. Additional information may also be included, such as a last update time, so that the age of the respective clock synchronization information for particular ones of a plurality of candidate endpoint nodes may be tracked and updated at a selected interval or based on a selected event.

Thus, the test protocol module 372 in the embodiments of FIG. 3B may be configured to generate one-way delay measurements as the obtained performance data based on timing information contained in received packets transmitted by an executed network test protocol. The voice performance characterization module 362 shown in FIG. 3A, in such cases, may be configured to generate terms such as a delay impairment term (I_{d}) of an overall transmission quality rating, such as an R-value, based on the one-way delay measurements received from one or more endpoint node devices. In other words, either the test protocol module 372 or the voice performance module 362 may be configured to generate the one-way delay measurements based on obtained timing information from communicated packets during an executed network test protocol.

While the present invention is illustrated, for example, with reference to the voice performance characterization module 362 being an application program in FIG. 3A, as will be appreciated by those of skill in the art, other configurations may also be utilized while still benefiting from the teachings of the present invention. For example, the voice performance characterization module 362 and/or the test protocol module 372 may also be incorporated into the operating system 352 or other such logical division of the data processing system 230. Thus, the present invention should not be construed as limited to the configuration of FIG. 3A and/or 3B but is intended to encompass any configuration capable of carrying out the operations described herein.

As noted in the background section above, it is known to generate and estimated Mean Opinion Scores (MOS) to characterize user satisfaction with a voice connection in a subjective manner as described in the ITU-T recommendation P.800 available from the International Telecommunication Union which is incorporated herein by reference as if set forth in its entirety. It is further known to extend from this subjective rating system to the E-model specified in ITU-T recommendation G.108 also available from the International Telecommunication Union which is incorporated herein by reference in its entirety, to generate an R-value to mathematically characterize performance of a voice communication connection in a network environment. Further information related to the E-model of voice communication performance characterization is provided in draft TS101329-5 v0.2.6 entitled “Telecommunications and Internet Protocol Harmonization Over Networks (IPHON), Part 5: Quality of Service (QoS) Measurement Methodologies” available from the European Telecommunications Standards Institute which is incorporated herein by reference as if set forth in its entirety.

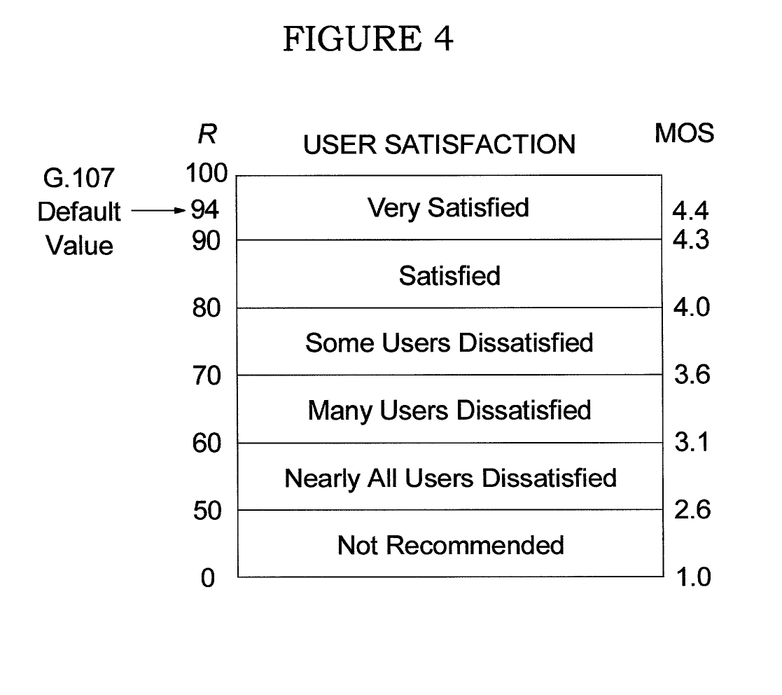

An overall transmission quality rating, such as the R-value, may further be used to estimate a subjective performance characterization, such as the MOS, as illustrated in FIG. 4. Thus, the calculated R-values ranging from 0 to 100 may be mapped to the MOS ratings from 1 to 4.5 such as by the illustrated mapping in FIG. 4. The present inventors, as will be now be described herein, have recognized that such voice communication characterization tools may be utilized in a manner which may provide quick, objective, repeatable and simple measurements of voice performance over a network in an advantageous manner as compared to conventional network performance testing approaches which were not developed with packetized voice communications and its unique user expectations in mind. Thus, the present invention provides for utilization of automatically and controllably generated network traffic to generate overall transmission quality measures to characterize a network in substantially “real” time as contrasted with offline simulations based on more generalized information and anecdotal measurements performed on a network and subsequently evaluated through human gathering of needed information and data entry to generate appropriate information and to test different network configurations.

The approach of the present invention is not limited solely to networks which are actively carrying packetized voice communications but may also be utilized to assess the readiness and expected performance level for a network that is configured to support such packetized voice communications before they are introduced to the network. Thus, the present invention may be used not only to track performance of a network on an on-going basis but may also be utilized to assess a network before deploying packetized voice communications on the network and may even be used to upgrade, tune or reconfigure such a network before allowing users access to packetized voice communications capabilities. The result of subsequent changes to the network which may be provided in support of voice communications or for other data communication demands of a network may also be assessed to determine their impact on voice communications in advance of or after such a change is implemented.

Before describing the present invention further and by way of background, further information on one particular overall performance measure, the R-value will now be further described.

The E-model R-value equation is expressed as:

R=R₀−Iₛ−I_{d}−Iₑ+A (1)

where R₀ is the basic signal to noise ratio (“the signal”); Iₛ is the simultaneous impairments; I_{d} is the delay impairments; Iₑ is the equipment impairments; and A is the access advantage factor. R may be mapped to an estimated MOS score. For example, a range of R from 0≦R≦93.2 may be mapped to a range of MOS from 1≦MOS≦4.5.

As will be further described, in accordance with the present invention, some of the terms used in generating the R-value may be held constant while others may be affected by obtained performance data from an executed network test protocol. For example, R₀ may be held constant across a plurality of different test protocol executions on a network at a value set on a base reference level or initially established based on some understanding of the noise characteristics of the network to be tested. Similarly, the access advantage factor will typically be set as a constant value across multiple network test protocol executions. In contrast, the delay impairment (I_{d}) and the equipment impairments (Iₑ) may be affected by the measured results in each execution of a network test protocol to objectively track network packetized voice communication performance capabilities over time.

The delay impairment factor (I_{d}) may be based on number of different measures. These measures may include the one-way delay as measured during a test, packetization delay and jitter buffer delay. The packetization delay may be readily modeled as a constant value in advance based upon the associated application software utilized to support packetized voice network communications. The jitter buffer delay may also be modeled as a constant value or based on an adaptive, but known, jitter buffer delay value if such is provided by the voice communication software implementing the jitter buffer feature. Thus, a one-way delay measurement may be the predominant variable characteristic measured during a network protocol test to influence the delay impairment factor (I_{d}). In accordance with various embodiments of the present invention, the packetization delay may take on different predetermined values based upon the codec used for a particular communication. It is known that different hardware codec devices have different delay characteristics. Exemplary packetization delay values suitable for use with the present invention may include 1.0 milliseconds (ms) for a G.711 codec, 25.0 ms for a G.729 codec and 67.5 ms for a G.723 codec.

The equipment impairment factor (Iₑ) is also typically affected by the selected codec. It will be understood by those of skill in the art that different codecs provide variable performance and that the selection of a given codec generally implies that a given level of quality is to be expected. Exemplary codec impairment values are provided in Table 1:

TABLE 1
Codec Comparison

| | Bit | Payload | | Packetization | Achieva- |
|---|---|---|---|---|---|
| | Rate | Size | Default Codec | Delay Values | ble MOS |
| Codec | (kbps) | (bytes) | Impairment | (ms) | value |
| G.711 | 64.0 | 240 | 0 | 1.0 | 4.41 |
| G.729 | 8.0 | 30 | 11 | 25.0 | 4.07 |
| G.723m | 6.3 | 24 | 15 | 67.5 | 3.88 |
| G.723a | 5.3 | 20 | 19 | 67.5 | 3.70 |

where the Default Codec Impairment in Table 1 is based on ITU G.113, appendix 1.

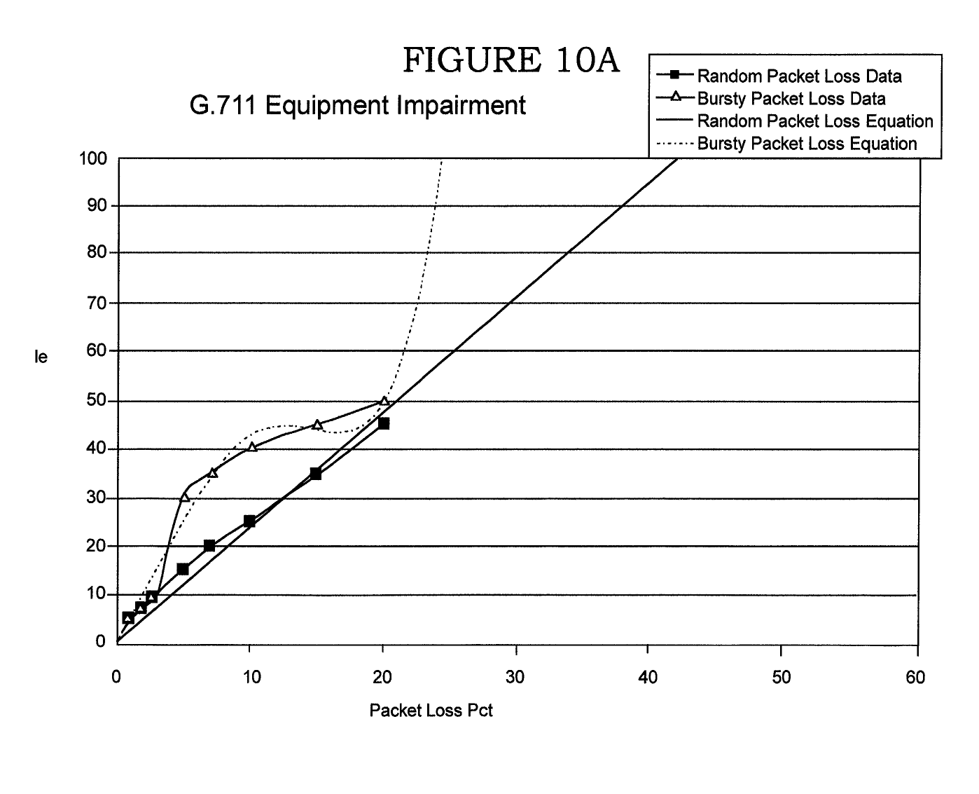

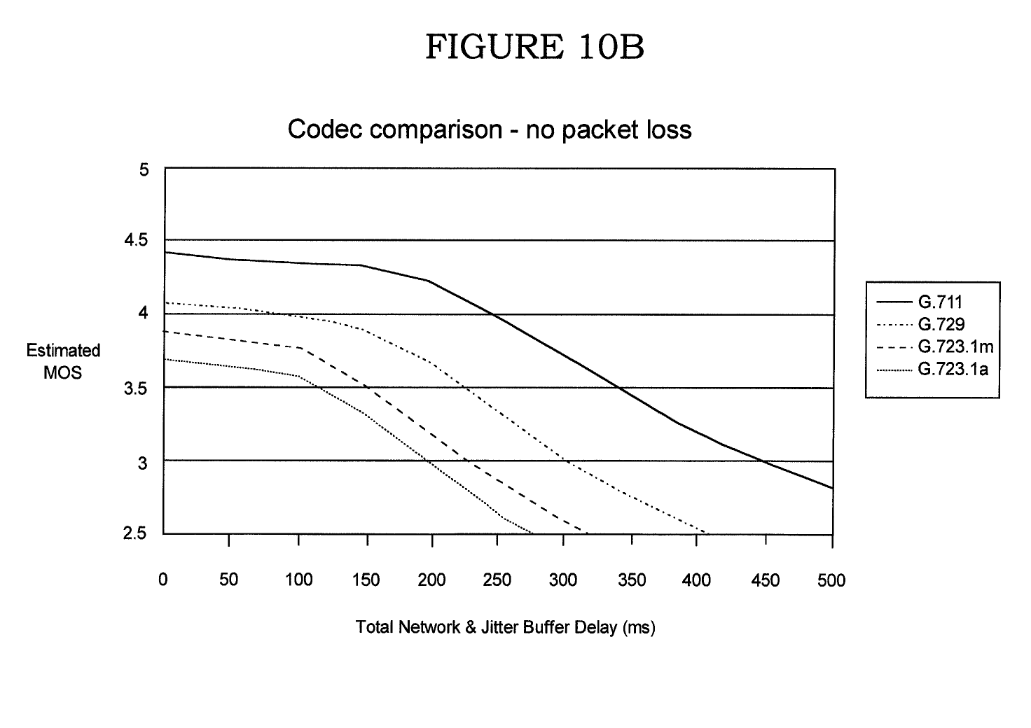

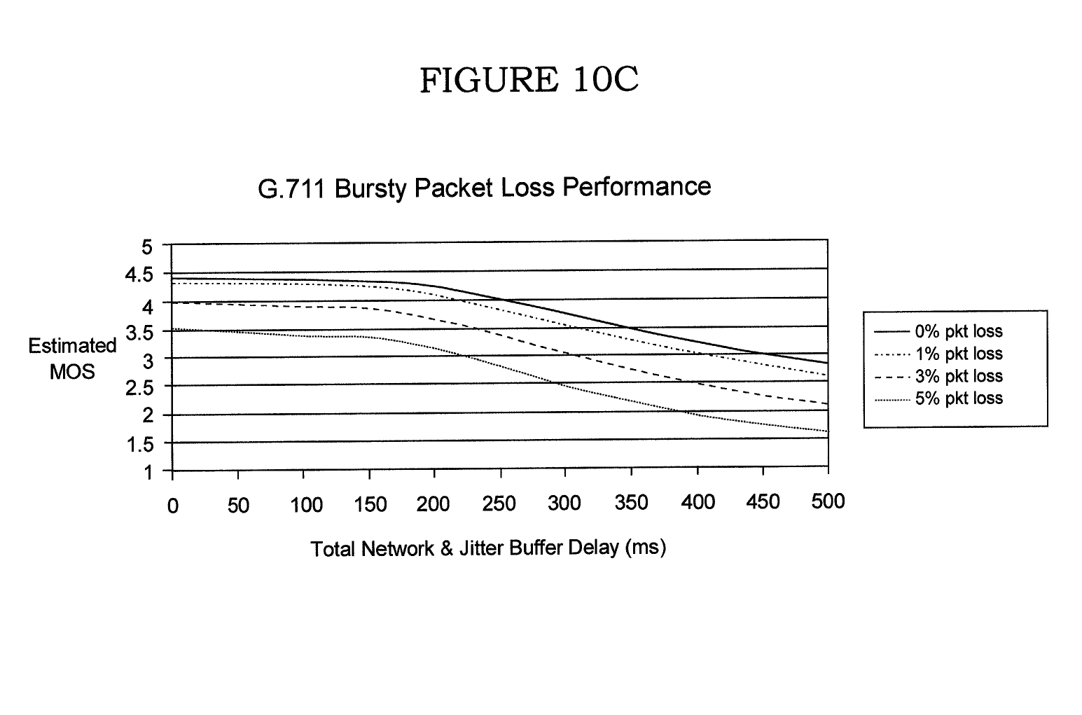

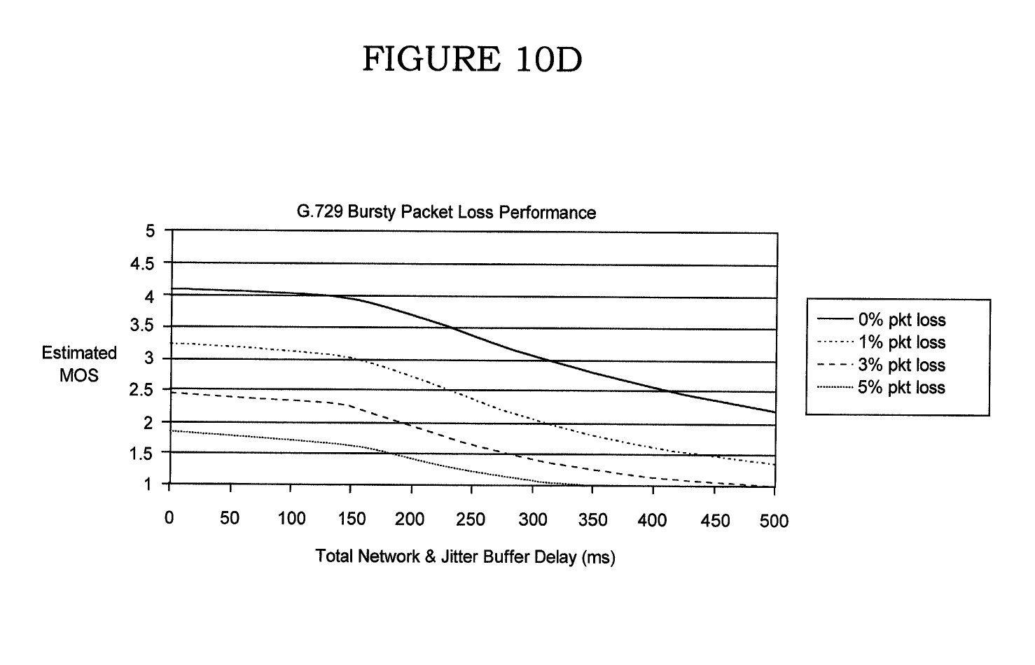

The equipment impairment factor (Iₑ) may also be affected by the percent of packet loss and may further be affected by the nature of the packet loss. For example, packet loss may be characterized as bursty, as contrasted with random, where bursty loss refers to the number of consecutive lost packets. For example, where N is the consecutive lost packet count, N greater than or equal to X may be characterized as a bursty loss while lower consecutive numbers of packets lost may be characterized as random packet loss and included in a count of all, including non-consecutive and consecutive packets lost. X may be set to a desired value, such as 5, to characterize and discriminate bursty packet loss from random packet loss. Note that the equipment impairment factor (Iₑ) is further documented in ITU G.113 and G.113/APP1 which are also available from the International Telecommunication Union and are incorporated herein by reference as if set forth in their entirety. Various codec related equipment performance characteristics are further illustrated in FIGS. 10A-10D as will be described further herein.

Thus, in various embodiments of the present invention, some characteristics, such as the codec, jitter buffer characteristics, silence suppression features or other known aspects may be specified in advance and modeled based on the specified values while data, such as one-way delay, packet loss and jitter, may be measured during execution of the network test protocol. These measurements may be made between any two endpoints in the network configured to operate as endpoint nodes and support such tests and may be concurrently evaluated utilizing a plurality of endpoint pairs for the communications and measurements. This measured and pre-characterized information may, in turn, be used to generate an overall transmission quality rating, such as an R-value. In various embodiments, the generated overall transmission quality rating may be further used to generate an estimated subjective rating, such as a Mean Opinion Score (MOS).

Such automated measurements may provide a quick and repeatable methodology for determining the quality of network voice performance, for example, to identify whether any problem exists or the severity of any such problem. These automated measurements may also be beneficial for network designers or routing equipment in determining a best path through a network for routing VoIP calls. By providing time associated characterizations in a normalized and automatic manner, benchmarking may also be supported to simplify comparisons in a manner that may be beneficial for assessing network performance under various conditions. The automation of the measurements and generation of the performance measures may also facilitate the utilization of the information by less trained personnel. Thus, the impact on the quality of a voice communication as affected by the data networks themselves may be assessed using various embodiments of the present invention. The present invention provides for doing so in a manner which recognizes unique aspects of a data communication network supporting packetized voice communications, as contrasted with a conventional PSTN type network, while still providing voice performance measurement results comparable to those which users are already familiar with from their experience with analog telephone systems.

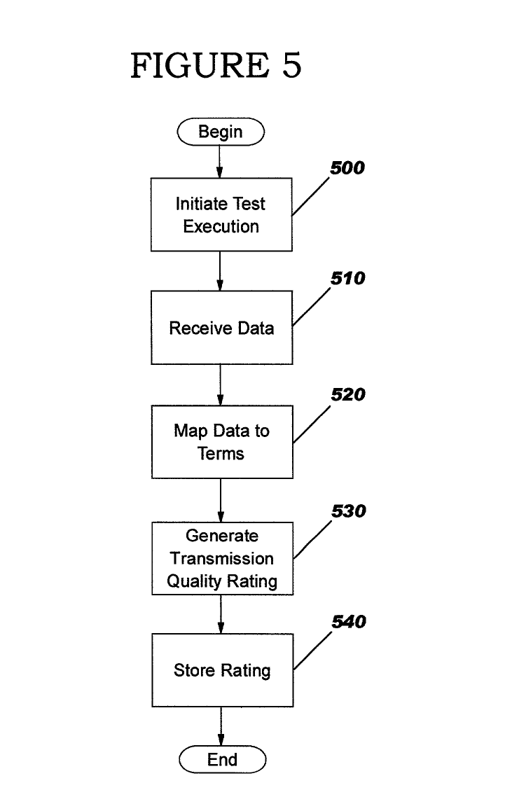

Referring now to the flowchart diagram of FIG. 5, operation for testing a network that supports packetized voice communications will be further described for various embodiments of the present invention. As shown in FIG. 5, operations begin at block 500 by initiating execution of a network test protocol associated with the packetized voice communications. Obtained performance data for the network based on the initiated network test protocol is automatically received, for example, from ones of the endpoint node devices executing the network test protocol (block 510). The test execution and the receipt of the obtained performance data may both be provided over the network being tested.

The obtained performance data is mapped to terms of an overall transmission quality rating (block 520). The overall transmission quality rating is generated based on the mapped obtained performance data (block 530). In various embodiments of the present invention, the generated overall transmission quality rating is also stored with an associated time based on when the network test protocol is executed to provide benchmarking of the network's performance (block 540).

Note that operations as described with reference to block 520, in various embodiments of the present invention, may further include associating one or more non-measured parameter values with the network test protocol. The overall transmission quality rating may then be generated based on the mapped obtained performance data and the associated plurality of non-measured parameter values. For example, as described above, the various codec related values may be set up as such non-measured parameter values for use in computing an overall transmission quality rating, such as an R-value. Note that the R-value is defined by the ITU and may be used to evaluate packetized voice communications, such as voice over Internet protocol (VoIP) communications.

While not shown in FIG. 5, the generated overall transmission quality rating may further be converted to a subjective measure, such as a Mean Opinion Score (MOS). The data received at block 510, may include different measured performance data such as a one-way delay, a network packet loss (such as a random packet loss), a jitter buffer packet loss (i.e., packets not lost on the network which were nonetheless lost due to discarding resulting from the use of a jitter buffer to smooth out packet arrival time for voice regeneration) and a network packet burst loss characteristic provided as a measure of the burstiness of the network packet loss which, in turn, may be used in determining a characteristic, such as Iₑ. The network packet burst loss characteristic may be derived from the measured network packet loss data rather than being a separately measured performance characteristic.

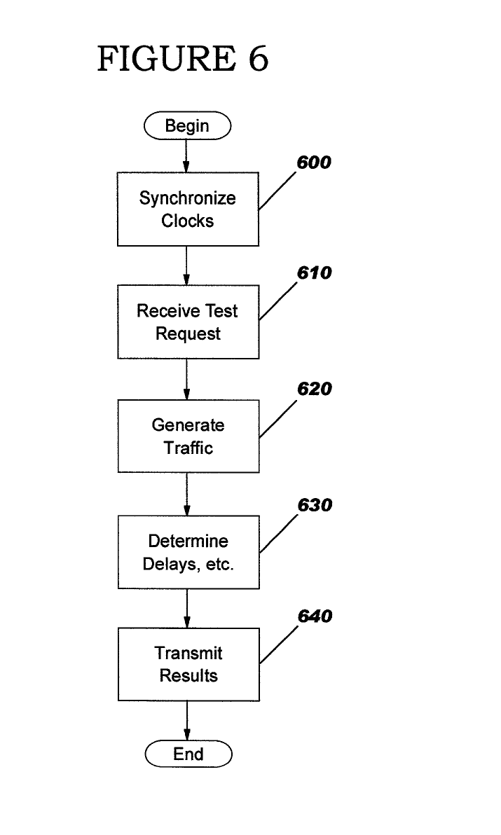

Operations for various embodiments of the present invention from the reference of the endpoint nodes included in an executed network test protocol will now be further described with reference to FIG. 6. The clocks of a first and second node, which nodes will be exchanging time stamped packets during execution of the test so as to generate one-way delay measurements, are synchronized prior to execution of the network test protocol (block 600). The synchronization operations, as will be described further herein, may be performed on a scheduled basis, an aging time-out basis and/or may be triggered for a refreshing of clock synchronization at the time a request is received to initiate execution of a test.

A test request is received, for example, from a console node device initiating execution of a test protocol (block 610). When the test is executed, the participating endpoint nodes generate traffic between the nodes for use in making measurements of the network voice communication performance (block 620). For example, the generated traffic may be specified by the protocol to emulate voice over IP (VOIP) communications. Delays, lost packet, duplicate packet and/or out of order packet measurements for the generated and communicated traffic are determined to provide the obtained performance data (block 630). The obtained performance data results are transmitted, for example, to the requesting console node which initiated the test, by ones of the endpoint nodes participating that have gathered designated performance measurement data (block 640).

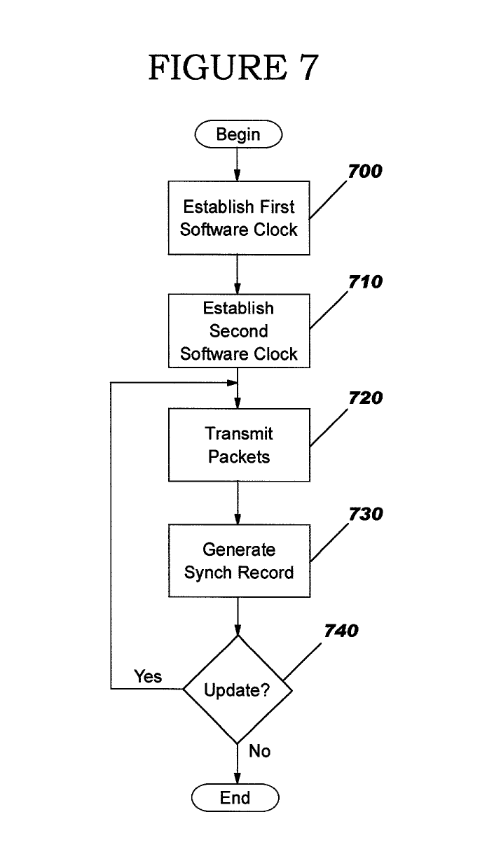

Referring now to the flowchart illustration of FIG. 7, operations for synchronizing a clock at a first node and a clock at a second node according to embodiments of the present invention will now be further described. A first software clock is established at the first node (block 700). A second software clock is established at the second node (block 710). Packets are transmitted from the first node to the second node that include a time of transmission record based on the first software clock (block 720). A synchronization record is generated at the second node based on the received time of transmission records from the communicated packets and the time provided by the second software clock (block 730). In addition to obtaining offset information between the first software clock and the second software clock relative to an absolute reference time, the synchronization operations across a plurality of communicated packets over time may be utilized to establish information, such as drift between the clocks, which may be used to predict the absolute clock time offset at a subsequent period in time after the synchronization operations described at block 720 and 730 are completed.

In any event, an update time may be specified and the steps of transmitting packets and generating synch records at block 720 and block 730 may be repeated to update the synchronization record information at the update times (block 740). Furthermore, the specified update time need not be a constant value and may be, for example, based upon the estimate drift characteristics between the two clocks. A more complete description of clock synchronization operations suitable for use with the present invention is provided in concurrently filed U.S. patent application Ser. No. ______, entitled “Methods, Systems and Computer Program Products for Synchronizing Clocks of Nodes on a Computer Network” (Attorney Docket No. 5670-13) which is incorporated by reference herein as if set forth in its entirety.

Delay measurements may also be provided based on the use of global positioning system (GPS) clock synchronization, rather than endpoint to endpoint clock synchronization through software clocks. In such embodiments, each endpoint may then include its GPS clock timestamp in responses for use in one-way delay measurements between endpoints. Such embodiments may, for example, be provided by GPS driver software that may interface to the GPS API on one side and present an endpoint clock synchronization interface on the other. Thus, for example, the clock synchronization module 371 may include GPS driver software for such embodiments of the present invention.

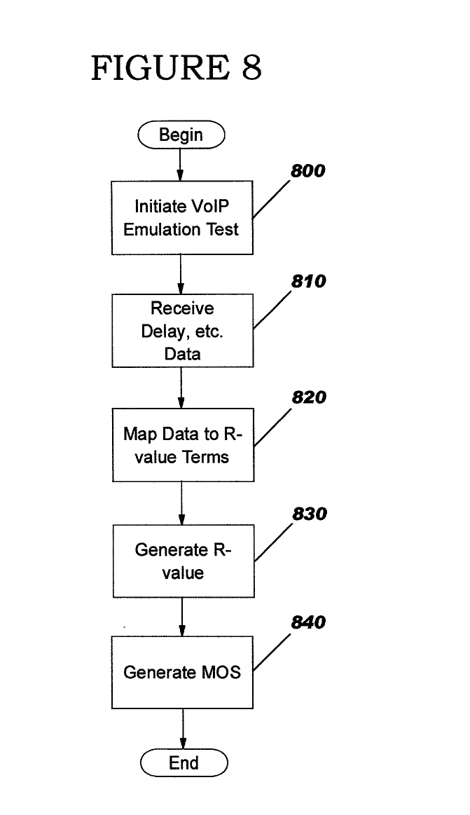

Referring now to the flowchart illustration of FIG. 8, operations for testing a network that supports VoIP communications according to further embodiments of the present invention will now be described. Execution of a network test protocol selected to emulate VoIP communications through communication traffic generated between selected nodes of the network is initiated (block 800). Obtained performance data for the network based on the initiated network test protocol is automatically received (block 810). The obtained performance data provides one-way delay measurements between ones of the selected nodes and/or packet loss measurements between ones of the selected nodes. Information related to the bursty or random nature of the packet loss measurements may also be provided. The obtained performance data is mapped to terms of an R-value (block 820). Where one-way delay measurements are provided, they are mapped at block 820 to a delay impairment (I_{d}) term of the R-value. Where packet loss measurements are provided at block 810, they are mapped to an equipment impairment (Iₑ) term of the R-value. The R-value is generated based on the mapped measurements and will typically also be based on constants or otherwise non-measured parameters (block 830). In various embodiments of the present invention where as subjective measure comparable to that used for analog telephone services is desired, an estimated Mean Opinion Score (MOS) is generated based on the R-value (block 840).

To further understand the mapping operations of the present invention, an example will now be provided illustrating the mapping of obtained performance data, including one-way delay, packet loss and bursty packet loss measurements, to terms used in calculating an R-value. Furthermore, this example will demonstrate the association of a number of non-measured parameter values with the test measurements and the use of the non-measured parameter values in arriving at the R-value.

For purposes of this example, the E-model calculates an R factor using the following formula:

R=Ro−Is−Id−Ie+A

where:

1) Ro is the basic signal-to-noise ratio. In other words, Ro is the base amount of signal which becomes impaired by a variety of factors. Due to the fixed parameters used in this example, Ro has a constant value of 94.77.

2) Is is the simultaneous impairments term. This is broken down into the terms, dealing with non-optimum handset characteristics, the number of complete analog-digital/digital to analog conversions, and non-optimum sidetone. The term Is is composed entirely of fixed parameters for purposes of this example, and is, thus, a constant of 1.43.

3) Id is the delay impairments term. Id is further subdivided into delay caused by talker echo (Idte), listener echo (Idle) and network delay (Idd). In accordance with embodiments of the present invention as illustrated by this example, additional impairments are added to Idd, specifically a term for delay caused by the jitter buffer (Idj) and the delay caused by codec packetization (idp). An additional device delay can also be provided. For this example, defaults are used as follows: Idte=0 and Idle=0.14904.

In determining Id for this example, Ta is the total delay including the measured one-way delay plus the jitter buffer delay plus the packetization delay and any optional configurable additional delay. If Ta≦100 ms, then Idd−0. If Ta>100 ms, then

$$Idd = 25 \{ {( 1 + {X}^{6} )}^{1 / 6} - 3 {( 1 + {[ \frac{X}{3} ]}^{6} )}^{1 / 6} + 2 \}$$

$$where$$

$$X = \frac{ln ( \frac{Ta}{100} )}{ln 2}$$

4) Ie is the equipment impairment term. This term is codec-based, and is based, for this example, upon the values provided in ITU G.113, Appendix 1. Percent lost packets (%lost packets) measured statistics and burstiness determination calculations based on these measured statistics are used in deriving Ie in accordance with the embodiments of the present invention illustrated by this example. The packet loss is deemed bursty in nature if the maximum consecutive number of lost packets is greater than 5. Different equations are applied for different codec types as provided below where the variable x is the percentage of lost packets:

### G.711 Codec

random: Ie=2.38499385x

bursty: Ie=0.00218497x⁴−0.07937952x³+0.67346636x²+3.31209543x

### G.729 Codec

random: Ie=0.00423674x³−0.19683230x²+4.43926576x+11.0

bursty: Ie=2.0*(0.00423674x³−0.19683230x²+4.43926576x+11.0)

### G.723.1m Codec

random: Ie=0.00703392x³−0.26604727x²+4.95509227x+15.0

bursty: Ie=2.0*(0.00703392x³−0.26604727x²+4.95509227x+15.0)

### G.723.1a Codec

random: Ie=0.00703392x³−0.26604727x²+4.95509227x+19.0

bursty: Ie=2.0*(0.00703392x³−0.26604727x²+4.95509227x+15.0)+4.0

5) A is the Access Expectation term. This is fixed at 0 for this example. Additional terms used for this example in to arrive at values from the E-model are described in Table 1 below.

TABLE 1

| | | | | |
|---|---|---|---|---|
| | | | Recommended range/ | Value used for |
| Parameter | Abbr. | Default value | notes | example |

Fixed (non-measured) parameters

| | | | | |
|---|---|---|---|---|
| Send Loudness Rating | SLR | +8 | 0 to +18 | 8 |
| Receive Loudness Rating | RER | +2 | 5 to +14 | 2 |
| Sidetone Masking Rating | STMR | 15 | 10 to 20 | 15 |
| Listener Sidetone Rating | LSTR | 18 | 13 to 23 | 18 |
| D-value of telephone, send side | Ds | 3 | −3 to +3 | 3 |
| D-value of telephone receive side | Dr | 3 | −3 to +3 | 3 |
| Talker Echo Loudness Rating | TELR | 65 | 5 to 65 | 65 |
| Weighted Echo Path Loss | WEPL | 110 | 5 to 110 | 110 |
| Number of Quantization | Qdu | 1 | 1 to 14 | 1 |
| distortion units | | | | |
| Circuit noise referred to 0 dBr- | Nc | 70 | −80 to −40 | −70 |
| point | | | | |
| Noise floor at the receive Side | Nfor | −64 | — | −64 |
| Room noise at the send side | Ps | 35 | 35 to 85 | 35 |
| Room noise at the receive side | Pr | 35 | 35 to 85 | 35 |
| Advantage factor | A | 0 | 0 to 20 | 0 |

Configuration-based (non-measured) parameters

| | | | | |
|---|---|---|---|---|
| Packetization Delay | Idp | 0 | Codec based: | G.711 codec |
| | | | G.711: 1 ms | chosen, with 1 ms |
| | | | G.723: 25 ms | packetization delay |
| | | | G.729: 67.5 ms | |
| Jitter Buffer Delay | Idj | 0 | User-configurable | 20 ms |

Measured parameters

| | | | | |
|---|---|---|---|---|
| % Packet Loss (both network | P1 | 0 | 0 to 100 | 5% |
| packet loss and jitter buffer | | | | |
| packet loss) | | | | |
| Absolute one-way delay in | Ta | 0 | 0 to infinity | 170 |
| echofree connections | | | | |

Dependant (calculated) parameters parameters

| | | | | |
|---|---|---|---|---|
| Packet Loss is Bursty | Pb | false | True if N > 5 | false |
| | | | False otherwise | |
| Mean one-way delay of the echo | T | 0 | T = Ta | 170 |
| path | | | | |
| Round trip delay in a 4-wire loop | Tr | 0 | Tr = 2.0 * Ta | 340 |

The resulting R value from the E-model may then be mapped to an estimated MOS value as follows:

For R<=0: MOS=1

For R>=100: MOS=4.5

For 0<R<100: MOS=1+0.035R+R(R−60)(100−R)7·10⁻⁶

Based on these assumptions, the value of R for a G.711 codec with a 20 ms jitter buffer, a 170 ms one-way network delay, and a 5% non-bursty packet loss is 74.86 and the MOS is 3.82.

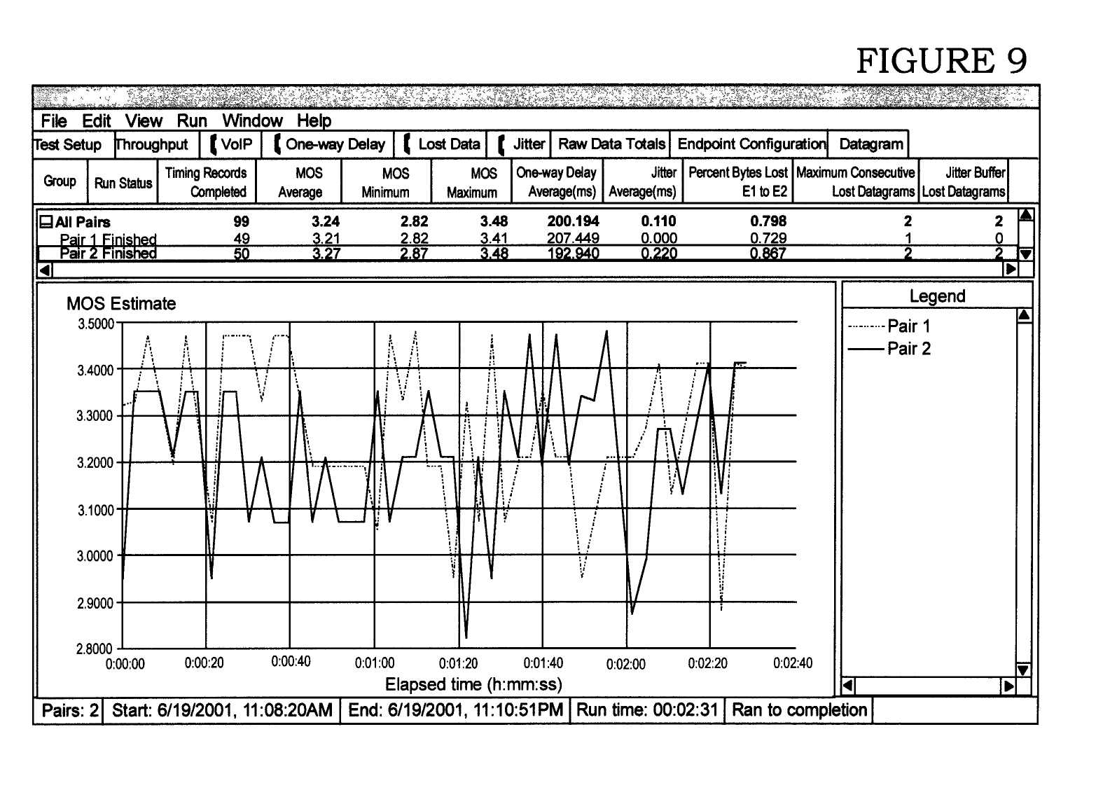

As noted above, the repeatable and simplified tracking of R-value or MOS to characterize network performance provided in accordance with various embodiments of the present invention may be utilized further to provide for benchmarking by storing the generated overall transmission quality ratings or MOS values with an associated time, which may be based on when the network test protocol is executed. An example of such benchmarking data is displayed in a graphic user interface is illustrated in FIG. 9.

As shown in FIG. 9, the graphical plotting of the MOS estimate is for a “Pair 1” and a “Pair 2.” Each measurement plotted on the graph is based on a test protocol in which 49 timing records are provided for Pair 1 and 50 timing records are provided for Pair 2 as shown in the upper window in FIG. 9. The resultant performance measurements from execution of a network test protocol at each iteration are shown as including the one-way delay average in milliseconds and the percent of bytes lost (i. e., network packet loss) between the respective endpoint one (E1) and endpoint two (E2) nodes which define Pair 1 and Pair 2. Maximum consecutive lost datagrams information is provided which presents information related to the burstiness of the packet loss on the network. The jitter buffer information presented in FIG. 9 is based upon a predetermined model of the jitter buffer for the connection and, thus, is, at least in part, a non-measured parameter value based on the fixed delay introduced by the jitter buffer. The lost packets or datagrams caused by the jitter buffer may be determined as a measured value. The MOS average, minimum and maximum are calculated based upon the test data and the non-measured parameter values. While only two pairs are used for plotting and tracking as shown in FIG. 9, it is to be understood that averaging and ranging information may be utilized to combine information from three or more endpoint pairs for an overall estimate of the network's performance. Furthermore, a full-duplex VoIP test may be considered as two connections between a pair of nodes, one connection being in each direction, which may simulate a phone call with communications in both directions.

As discussed above, the codec type typically impacts on user perception of call quality and, thus, is desirably factored into the calculated R-value and resulting MOS estimate. FIG. 10A is a graphical illustration of equipment impairment characteristics of a G.711 type codec plotting packet loss percentage against equipment impairment (Iₑ). More particularly, FIG. 10A shows two plots of data values, one for G.711 random packet loss and the other for G.711 bursty packet loss, as well as the random packet loss and bursty packet loss equations (i.e., for each plotted set of points, a well-fitting regression has been determined and plotted). These regression equations may be used for determining Iₑ related to the observed packet loss and the nature (burstiness) of the packet loss. FIG. 10B shows a comparison between different codec types assuming no packet loss in a configuration in which no jitter buffer is used. The total delay in milliseconds (ms) information is plotted against estimated MOS for each of four different types of codec. FIG. 10C illustrates packet loss performance for a G.711 type codec assuming no jitter buffer and a variety of different percentages of packet loss with total delay again mapped against estimated MOS. Finally, FIG. 10D illustrates information corresponding to that described for FIG. 10C but plotted for a G.729 type codec. It is to be understood that the information presented with respect to various codecs in FIGS. 10A-10D is by way of example and that similar information can be generated for other codec types for use in providing measurements of overall transmission quality in a voice communication type network as described above.

One non-measured parameter which may be beneficially utilized in providing an R-value in accordance with various embodiments of the present invention relates to jitter buffer delay and/or jitter buffer packet loss. It will be understood by those of skill in the art that a jitter buffer may occasionally introduce a packet loss for a packet that was successfully received over the network but arrived too early or too late to be played out correctly or was otherwise not processed quickly enough to be passed through the jitter buffer successfully. Such losses typically are accepted because excessive sizing of the jitter buffer would generally introduce additional delay which is also typically not desirable. In accordance with various embodiments of the present invention, a jitter buffer size may be specified by a user in milliseconds or in numbers of datagrams (packets). The jitter buffer size in milliseconds may then be utilized as an additional delay component in determining the delay impairment value (I_{d}) in calculating the R-value. A receiving endpoint may also identify packets that would result in a jitter buffer overrun based on this timing information and count such packets in a jitter buffer loss data statistic. Such packets, which were not actually lost on the network, would appear as lost to the voice communication application and may be recorded as such in testing operations in accordance with embodiments of the present invention. Additional statistics, including an accounting of the numbers of jitter buffer overruns, may also be supported. Alternatively, a dynamic jitter buffer may be specified that is adjusted based on the network performance where further information is available about the jitter buffer behavior of the hardware and software applications supporting voice over IP communications on a network.

Thus, where a jitter buffer model is included in the communication link between the two endpoints, the end to end delay may be measured by a packetization delay (which may be a nonmeasured specified value based on the codec type) added to the jitter buffer size in milliseconds plus a measured one-way delay from a test sequence to provide a total delay in milliseconds. In addition, the jitter buffer lost datagrams may be added to the count of datagrams lost during network communications to specify a total loss seen by the packetized voice communication application. The percentage of lost datagrams packets may then be based on the lost count over the total datagrams communicated during the test cycle. Note that the particular characteristics of the jitter buffer are otherwise generally known to those of skill in the art and will not be further described herein. An example of an adaptive jitter buffer is provided, for example, at www.cisco.com/univercd/cc/td/doc/product/voice/ip_tele/avvidqos/qosintro.htm#9 0219.

It will be understood that the block diagram and circuit diagram illustrations of FIGS. 1-3B and 5-8 combinations of blocks in the block and circuit diagrams may be implemented using discrete and integrated electronic circuits. It will also be appreciated that blocks of the block diagram and circuit illustration of FIGS. 1-3B and 5-8 and combinations of blocks in the block and circuit diagrams may be implemented using components other than those illustrated in FIGS. 1-3B and 5-8, and that, in general, various blocks of the block and circuit diagrams and combinations of blocks in the block and circuit diagrams, may be implemented in special purpose hardware such as discrete analog and/or digital circuitry, combinations of integrated circuits or one or more application specific integrated circuits (ASICs).

Accordingly, blocks of the circuit and block diagrams of FIGS. 1-3B and 5-8 support electronic circuits and other means for performing the specified operations, as well as combinations of operations. It will be understood that the circuits and other means supported by each block and combinations of blocks can be implemented by special purpose hardware, software or firmware operating on special or general purpose data processors, or combinations thereof. It should also be noted that, in some alternative implementations, the operations noted in the blocks may occur out of the order noted in the figures. For example, two blocks shown in succession may, in fact, be executed substantially concurrently, or the blocks may sometimes be executed in the reverse order.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. A method for evaluating a network that supports packetized voice communications, the method comprising the steps of:
initiating execution of a network test protocol associated with the packetized voice communications;
automatically receiving obtained performance data for the network based on the initiated network test protocol;
mapping the obtained performance data to terms of an overall transmission quality rating; and
generating the overall transmission quality rating based on the mapped obtained performance data.

2. The method of claim 1 further comprising the step of storing at least one of the generated overall transmission quality rating or the terms of the overall transmission quality rating with an associated time of the obtained performance data based on when the network test protocol is executed to provide benchmarking of network performance.

3. The method of claim 1 further comprising the step of associating a plurality of non-measured parameter values with the initiated network test protocol and wherein the step of generating the overall transmission quality rating comprises the step of generating the overall transmission quality rating based on the mapped obtained performance data and the associated plurality of non-measured parameter values.

4. The method of claim 1 wherein the packetized voice communications comprises voice over Internet protocol (VoIP) communications and wherein the overall transmission quality rating comprises an R-value.

5. The method of claim 4 further comprising converting the R-value to an estimated Mean Opinion Score (MOS).

6. The method of claim 1 wherein the step of automatically receiving obtained performance data comprises the step of receiving at least one of a one-way delay, a network packet loss and a jitter buffer packet loss.

7. The method of claim 6 wherein the method further comprises the step of automatically obtaining the performance data based on the executed network test protocol and wherein the network test protocol specifies a communication from a first node on the network to a second node on the network and wherein the step of automatically obtaining the performance data comprises the steps of:
synchronizing a clock at the first node and a clock at the second node; and
determining a delay for the communication from the first node to the second node to provide the one-way delay.

8. The method of claim 7 wherein the step of synchronizing a clock at the first node and a clock at the second node comprises:
establishing a first software clock at the first node;
establishing a second software clock at the second node;
transmitting packets from the first node to the second node, the packets including a time of transmission record based on the first software clock;
generating a synchronization record at the second node based on the received time of transmission records and the second software clock; and
intermittently repeating the transmitting packets and generating a synchronization record steps to update the synchronization record.

9. The method of claim 1 wherein the method further comprises the step of automatically obtaining the performance data based on the executed network test protocol and wherein the network test protocol specifies communication packets from a first node on the network to a second node on the network and wherein the step of automatically obtaining the performance data comprises the steps of:
determining a one-way delay between the first and second node based on the communication packets from the first node to the second node; and
determining a network packet loss based on the communication packets from the first node to the second node.

10. The method of claim 9 wherein the overall transmission quality rating comprises an R-value including an equipment impairment (Iₑ) term and a delay impairment (I_{d}) term and wherein the step of mapping the obtained performance data comprises the step of determining the delay impairment (I_{d}) based on the determined one-way delay and determining the equipment impairment (Iₑ) based on the determined network packet loss.

11. The method of claim 10 wherein the network test protocol specifies communication packets between a plurality of network node pairs and wherein the step of determining a one-way delay and determining a network packet loss are based on the communication packets between the plurality of network node pairs.

12. The method of claim 1 wherein the overall transmission quality rating comprises an R-value and wherein the terms of the R-value comprise a delay impairment (I_{d}) and an equipment impairment (Iₑ) and wherein the step of mapping the obtained performance data comprises the steps of:
generating the delay impairment (I_{d}) based on one-way delays for the plurality of network node pairs determined from the obtained performance data; and
generating the equipment impairment (Iₑ) based on network packet losses for the plurality of network node pairs determined from the obtained performance data.

13. A method for evaluating a network that supports voice over internet protocol (VoIP) communications, the method comprising the steps of:
initiating execution of a network test protocol selected to emulate VoIP communications through communication traffic generated between selected nodes of the network;
automatically receiving obtained performance data for the network based on the initiated network test protocol, the obtained performance data providing at least one of one-way delay measurements between ones of the selected nodes and packet loss measurements between ones of the selected nodes;
mapping at least one of the one-way delay measurements to a delay impairment (I_{d}) term of an R-value or the packet loss measurements to an equipment impairment (Iₑ) term of the R-value; and
generating the R-value based on the mapped measurements.

14. A system for evaluating a network that supports packetized voice communications, the system comprising:
a test initiation module that transmits over the network to nodes coupled to the network a request to initiate execution of a network test protocol associated with the packetized voice communications;
a receiver that receives over the network obtained performance data for the network based on the initiated network test protocol; and
a voice performance characterization module that maps the obtained performance data to terms of an overall transmission quality rating and that generates the overall transmission quality rating based on the mapped obtained performance data.

15. The system of claim 14 wherein the test initiation module, the receiver and the voice performance characterization module execute on a control node coupled to the network, the system further comprising a plurality of endpoint nodes, ones of the endpoint nodes comprising:
a receiver that receives the request to initiate execution of the network test protocol;
a test protocol module that executes the network test protocol responsive to a received request to initiate execution of the network test protocol to provide the obtained performance data; and
a reporting module that transmits the obtained performance data to the control node over the network.

16. The system of claim 15 wherein the test protocol module is further configured to generate one-way delay measurements as the obtained performance data based on timing information contained in received packets transmitted by the executed network test protocol and wherein the voice performance characterization module is further configured to generate a delay impairment term (I_{d}) of the overall transmission quality rating based on the one-way delay measurements.

17. The system of claim 15 wherein the test protocol module is further configured to provide timing information contained in received packets transmitted by the executed network test protocol as the obtained performance data and wherein the voice performance characterization module is further configured to generate one-way delay measurements based on the timing information and to generate a delay impairment term (I_{d}) of the overall transmission quality rating based on the one-way delay measurements.

18. A system for evaluating a network that supports packetized voice communications, the system comprising:
means for initiating execution of a network test protocol associated with the packetized voice communications;
means for automatically receiving obtained performance data for the network based on the initiated network test protocol;
means for mapping the obtained performance data to terms of an overall transmission quality rating; and
means for generating the overall transmission quality rating based on the mapped obtained performance data.

19. The system of claim 18 further comprising means for storing at least one of the generated overall transmission quality rating or the terms of the overall transmission quality rating with an associated time of the obtained performance data based on when the network test protocol is executed to provide benchmarking of network performance.

20. The system of claim 18 further comprising means for associating a plurality of non-measured parameter values with the initiated network test protocol and wherein the means for generating the overall transmission quality rating comprises means for generating the overall transmission quality rating based on the mapped obtained performance data and the associated plurality of non-measured parameter values.

21. The system of claim 18 wherein the packetized voice communications comprises voice over Internet protocol (VoIP) communications and wherein the overall transmission quality rating comprises an R-value and wherein the system further comprises means for converting the R-value to an estimated Mean Opinion Score (MOS).

22. The system of claim 18 wherein the means for automatically receiving obtained performance data comprises means for receiving at least one of a one-way delay, a network packet loss and a jitter buffer packet loss.

23. The system of claim 18 further comprising means for automatically obtaining the performance data based on the executed network test protocol and wherein the network test protocol specifies communication packets from a first node on the network to a second node on the network and wherein the means for automatically obtaining the performance data comprises:
means for determining a one-way delay between the first and second node based on the communication packets from the first node to the second node; and
means for determining a network packet loss based on the communication packets from the first node to the second node.

24. The system of claim 23 wherein the overall transmission quality rating comprises an R-value including an equipment impairment (Iₑ) term and a delay impairment (I_{d}) term and wherein the means for mapping the obtained performance data comprises means for determining the delay impairment (I_{d}) based on the determined one-way delay and determining the equipment impairment (Iₑ) based on the determined network packet loss.

25. The system of claim 24 wherein the network test protocol specifies communication packets between a plurality of network node pairs and wherein the means for determining a one-way delay and determining a network packet loss are based on the communication packets between the plurality of network node pairs.

26. The system of claim 18 wherein the overall transmission quality rating comprises an R-value and wherein the terms of the R-value comprise a delay impairment (I_{d}) and an equipment impairment (Iₑ) and wherein the means for mapping the obtained performance data comprises:
means for generating the delay impairment (I_{d}) based on one-way delays for the plurality of network node pairs determined from the obtained performance data; and
means for generating the equipment impairment (Iₑ) based on network packet losses for the plurality of network node pairs determined from the obtained performance data.

27. A computer program product for evaluating a network that supports packetized voice communications, the computer program product comprising:
a computer-readable storage medium having computer-readable program code embodied in said medium, said computer-readable program code comprising:
computer-readable program code which initiates execution of a network test protocol associated with the packetized voice communications;
computer-readable program code which automatically receives obtained performance data for the network based on the initiated network test protocol;
computer-readable program code which maps the obtained performance data to terms of an overall transmission quality rating; and
computer-readable program code which generates the overall transmission quality rating based on the mapped obtained performance data.

28. The computer program product of claim 27 further comprising computer-readable program code which stores at least one of the generated overall transmission quality rating or the terms of the overall transmission quality rating with an associated time of the obtained performance data based on when the network test protocol is executed to provide benchmarking of network performance.

29. The computer program product of claim 27 further comprising computer-readable program code which associates a plurality of non-measured parameter values with the initiated network test protocol and wherein the computer-readable program code which generates the overall transmission quality rating comprises computer-readable program code which generates the overall transmission quality rating based on the mapped obtained performance data and the associated plurality of non-measured parameter values.

30. The computer program product of claim 27 wherein the packetized voice communications comprises voice over Internet protocol (VOIP) communications and wherein the overall transmission quality rating comprises an R-value and wherein the system further comprises computer-readable program code which converts the R-value to an estimated Mean Opinion Score (MOS).

31. The computer program product of claim 27 wherein the computer-readable program code which automatically receives obtained performance data comprises computer-readable program code which receives at least one of a one-way delay, a network packet loss and a jitter buffer packet loss.

32. The computer program product of claim 27 further comprising computer-readable program code which automatically obtains the performance data based on the executed network test protocol and wherein the network test protocol specifies communication packets from a first node on the network to a second node on the network and wherein the computer-readable program code which automatically obtains the performance data comprises:
computer-readable program code which determines a one-way delay between the first and second node based on the communication packets from the first node to the second node; and
computer-readable program code which determines a network packet loss based on the communication packets from the first node to the second node.

33. The computer program product of claim 32 wherein the overall transmission quality rating comprises an R-value including an equipment impairment (Iₑ) term and a delay impairment (I_{d}) term and wherein the computer-readable program code which maps the obtained performance data comprises computer-readable program code which determines the delay impairment (I_{d}) based on the determined one-way delay and determines the equipment impairment (Iₑ) based on at least one of the determined network packet loss and a characterization of the network packet loss burstiness.

34. The computer program product of claim 33 wherein the network test protocol specifies communication packets between a plurality of network node pairs and wherein the computer-readable program code which determines a one-way delay and determines a network packet loss are based on the communication packets between the plurality of network node pairs.

35. The computer program product of claim 27 wherein the overall transmission quality rating comprises an R-value and wherein the terms of the R-value comprise a delay impairment (I_{d}) and an equipment impairment (Iₑ) and wherein the computer-readable program code which maps the obtained performance data comprises:
computer-readable program code which generates the delay impairment (I_{d}) based on one-way delays for the plurality of network node pairs determined from the obtained performance data; and
computer-readable program code which generates the equipment impairment (Iₑ) based on network packet losses for the plurality of network node pairs determined from the obtained performance data.
